(19) United States
(12) Patent Application Publication
(10) Pub. No.: US 2019/0303114 A1
(43) Pub. Date: Oct. 3, 2019

(54) PROGRAM CREATING APPARATUS, PROGRAM CREATING METHOD, AND NON-TRANSITORY COMPUTER READABLE MEDIUM

(71) Applicant: PANASONIC INDUSTRIAL DEVICES SUNX CO., LTD., Aichi (JP)

(72) Inventors: Kiyoshi TOKASHIKI, Aichi (JP); Shohei ISHII, Gifu (JP); Koji SHIINA, Aichi (JP); Yumi ONO, Aichi (JP); Naoaki NODA, Aichi (JP); Hidenori SHIRAI, Aichi (JP)

(21) Appl. No.: 16/284,195

(22) Filed: Feb. 25, 2019

(30) Foreign Application Priority Data
Mar. 29, 2018 (JP) 2018-066250

(51) Int. Cl. G06F 8/38; G06T 7/00; G06F 8/20

(52) U.S. Cl. CPC G06F 8/38; G06F 8/20; G06T 7/0004

(57) ABSTRACT

A program creating apparatus for an image inspection program creates the image inspection program used in an image inspection apparatus configured to capture an image of an inspection target and execute image inspection of the inspection target. The program creating apparatus includes: a processing unit configured to execute processing including creating processing of the image inspection program and operation confirmation processing of the image inspection program. The processing unit displays a program creating screen related to creating of the image inspection program on a display device, describes a flowchart by allocating items including processing items related to image inspection in accordance with a user operation on the program creating screen, thereby creating an image inspection program including image inspection items according to the flowchart, and displays processing information corresponding to each of the processing items on the program creating screen.

### CROSS-REFERENCES TO RELATED APPLICATIONS

This application is based on and claims priority from Japanese Patent Application No. 2018-066250 filed on Mar. 29, 2018, the entire contents of which are incorporated herein by reference.

### FIELD

One or more embodiments of the present invention relate to a program creating apparatus, a program creating method, and a non-transitory computer readable medium storing a creating program for an image inspection program which are applied to an image inspection apparatus that executes image processing and inspection of a captured image as an inspection such as quality determination of products in a production process in a production facility such as a factory.

### BACKGROUND

In recent years, a large number of image inspection systems capable of accurately and automatically performing various visual inspections depending on human vision at a high speed have been introduced as a production facility such as a factory. Various creating apparatuses for creating an image inspection program to operate such types of image inspection systems have been proposed. For example, JP-A-2009-123069 discloses a program creating apparatus that creates a control program of an image processing controller outputting a determination signal based on a camera image obtained by imaging an inspection target.

The program creating apparatus includes a program generation unit that generates a control program that acquires a camera image from a camera based on an imaging trigger signal and extracts a measurement result from the acquired camera image as the control program of an image processing controller, a simulation unit that executes the control program, and a transport unit that transports the control program to the image processing controller, in which the simulation unit includes an off-line simulation unit that extracts a measurement result from a camera image already stored as a registered image and an on-line simulation unit that acquires a camera image from the camera through the image processing controller during the execution of the control program and extracts a measurement result from the acquired camera image. According to such a type of program creating apparatus, it is possible to improve operability when confirming the operation of a created control program.

### SUMMARY

In the above-described creating apparatus for an image inspection program, it is possible to perform off-line simulation that extracts a measurement result from a camera image already stored as a registered image and on-line simulation that extracts a measurement result from a camera image acquired through an image processing controller during the execution of a control program. However, it is possible to acquire only the final result of measurement and it is not possible to acquire conditions and results for each processing item in image inspection to confirm the operation of the image inspection program in detail.

One or more embodiments of the present invention have been made in view of the above-described circumstances of the related art, and an object thereof is to provide a program creating apparatus, a program creating method, and a non-transitory computer readable medium storing a creating program for an image inspection program by which capable of simply performing detailed operation confirmation for each processing item in the image inspection program.

One or more embodiments of the present invention provide a program creating apparatus for an image inspection program, which creates the image inspection program used in an image inspection apparatus configured to capture an image of an inspection target and execute image inspection of the inspection target, the program creating apparatus including: a processing unit configured to execute processing including creating processing of the image inspection program and operation confirmation processing of the image inspection program, wherein the processing unit displays a program creating screen related to creating of the image inspection program on a display device, describes a flowchart by allocating items including processing items related to image inspection in accordance with a user's operation on the program creating screen, thereby creating an image inspection program including image inspection items according to the flowchart, and displays processing information corresponding to each of the processing items on the program creating screen.

One or more embodiments of the present invention provide a program creating method for an image inspection program in a program creating apparatus configured to create the image inspection program used in an image inspection apparatus configured to capture an image of an inspection target and execute image inspection of the inspection target, the program creating method including: executing, by a processing unit of the program creating apparatus, processing including creating processing of the image inspection program and operation confirmation processing of the image inspection program; displaying, by the processing unit of the program creating apparatus, a program creating screen related to creating of the image inspection program on a display device, and describing a flowchart by allocating items including processing items related to image inspection in accordance with a user's operation on the program creating screen, thereby creating an image inspection program including image inspection items according to the flowchart; and displaying, by the processing unit of the program creating apparatus, processing information corresponding to each of the processing items on the program creating screen.

One or more embodiments of the present invention provide a non-transitory computer readable medium storing a creating program for an image inspection program, which causes a computer to execute a program creating process in a program creating apparatus configured to create the image inspection program used in an image inspection apparatus configured to capture an image of an inspection target and execute image inspection of the inspection target, the program creating process comprising: executing processing including creating processing of the image inspection program and operation confirmation processing of the image inspection program; displaying a program creating screen related to creating of the image inspection program on a display device, and describing a flowchart by allocating items including processing items related to image inspection in accordance with a user's operation on the program creating screen, thereby creating an image inspection program including image inspection items according to the flowchart; and displaying processing information corresponding to each of the processing items on the program creating screen.

According to one or more embodiments of the present invention, it is possible to simply perform detailed operation confirmation for each processing item in the image inspection program.

### BRIEF DESCRIPTION OF DRAWINGS

FIG. 1 is a diagram illustrating a configuration example of an image inspection system according to the present embodiment;

FIG. 2 is a block diagram illustrating a configuration example of an image inspection apparatus according to the present embodiment;

FIG. 3 is a perspective view illustrating an example of the exterior configuration of the image inspection apparatus according to the present embodiment;

FIG. 4 is a bottom view illustrating an example of the exterior configuration of the image inspection apparatus according to the present embodiment;

FIG. 5 is a block diagram illustrating a configuration example of a program creating apparatus according to the present embodiment;

FIG. 6 is a diagram illustrating an example of a program creating screen according to a first embodiment;

FIG. 7 is a diagram illustrating an example of the program creating screen according to the first embodiment;

FIG. 8 is a diagram illustrating an example of a program confirmation screen according to the first embodiment;

FIG. 9 is a diagram illustrating an example of the program confirmation screen according to the first embodiment;

FIG. 10 is a block diagram illustrating an example of a connection configuration of a program creating apparatus according to a second embodiment;

FIG. 11 is a diagram illustrating an example of a program creating screen according to the second embodiment; and

FIG. 12 is a diagram illustrating an example of an image inspection program according to the second embodiment.

### DETAILED DESCRIPTION

Hereinafter, embodiments specifically disclosing a program creating apparatus, a program creating method, and a non-transitory computer readable medium storing a creating program for an image inspection program according to the present invention will be described in detail with reference to the accompanying drawings as appropriate.

In the present embodiment, as the image inspection apparatus and the image inspection system, description will be given of an example of a configuration in which image inspection of a target or the like in a production line is performed in a production facility controlled by a programmable logic controller (PLC) provided in, for example, a factory or the like.

### Configuration Example of Image Inspection System

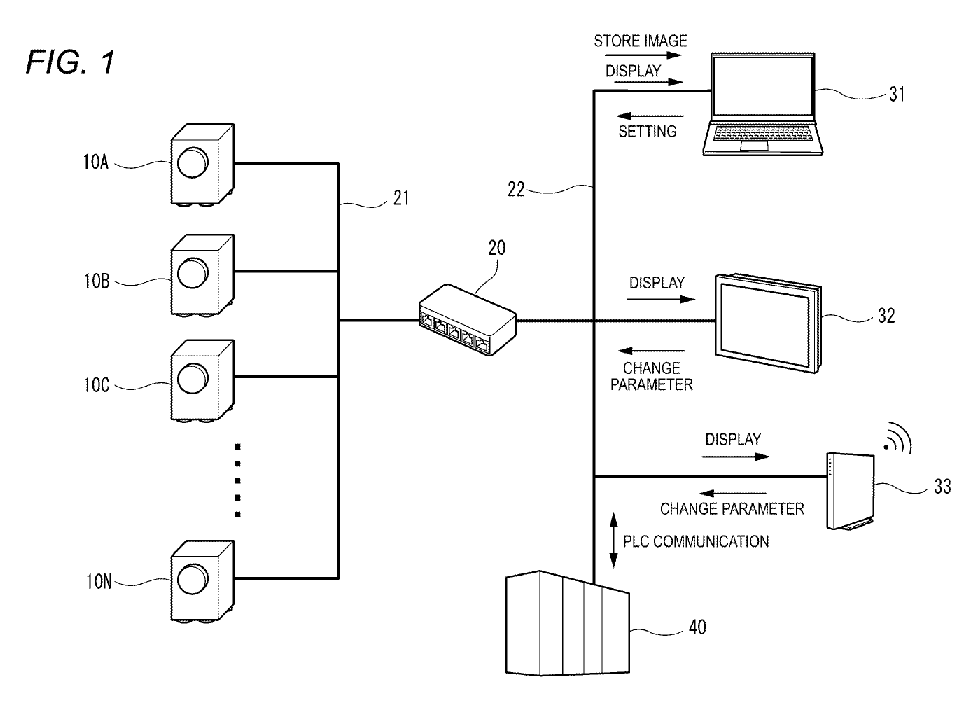

FIG. 1 is a diagram illustrating a configuration example of the image inspection system according to the present embodiment. The image inspection system includes a plurality of (for example, N) image inspection apparatuses 10A, 10B, 10C, □, and 10N. The plurality of image inspection apparatuses 10A to 10N may be representatively referred to as an image inspection apparatus 10. The image inspection apparatus 10 is also referred to as an image sensor, an image processing apparatus, or the like, and has a function of imaging a target and image processing and inspecting the captured image according to a predetermined image inspection program. The image inspection apparatuses 10A to 10N, which are connected to a wired or wireless network 21 as a communication interface, input and output various types of information such as image information, setting information, and inspection result information.

The image inspection apparatuses 10A to 10N are connected to another wired or wireless network 22 as a communication interface through a HUB 20. A personal computer (PC) 31, a monitor terminal 32, a wireless local area network (LAN) router 33, and a programmable logic controller (PLC) 40 are connected to the network 22.

The example illustrated in the drawing shows a configuration in which the networks 21 and 22 constituting the communication interface are connected to a network by a wired LAN such as Ethernet (registered trademark). Various wired or wireless networks and communication lines can be used as the communication interface as long as communication can be performed using a general-purpose protocol to be described later. Here, a configuration example in which the image inspection apparatuses 10A to 10N are connected to various terminals and devices such as the PC 31 and the monitor terminal 32 through the plurality of networks 21 and 22 is shown, but a connection state is not limited thereto. The image inspection apparatus 10 may be connected to a terminal or a device through a single network or may be directly connected to a terminal or a device.

The PC 31 includes a processor, a memory, a display device such as a display, and an input device such as a keyboard, and includes a processing unit having a function of operating an application such as a browser and an image inspection program preparation tool. The PC 31 performs processes such as setting the image inspection apparatus 10, displaying an inspection image acquired by the image inspection apparatus 10, and saving the inspection image. The inspection image acquired by the image inspection apparatus 10 includes not only image information of the captured image but also various types of inspection result information obtained through image processing. The PC 31 configures a program creating apparatus configured to create an image inspection program, and can execute processing for creating the image inspection program. Instead of the PC 31, an information processing apparatus such as a tablet terminal and a smart phone which has a display function and a communication function may be connected and used.

The monitor terminal 32, which is a monitoring device used exclusively for an image inspection system or a monitoring device usable for other purposes, includes a display device such as a display, a memory, and an input device such as a touch panel and includes a processing unit which has a function of operating an application such as a browser. The monitor terminal 32 performs processes such as displaying the inspection image acquired by the image inspection apparatus 10 and changing parameters of the image inspection apparatus 10.

The browsers mounted on the PC 31 and the monitor terminal 32, which are also referred to as web browsers, access a predetermined uniform resource locator (URL) on an Internet protocol (IP) network, perform communication using a general-purpose protocol represented by HyperText transfer protocol (HTTP), and display contents (web contents) written in languages such as HyperText markup language (HTML) and extensible markup language (XML), The PC 31 and the monitor terminal 32 can access the image inspection apparatuses 10A to 10N by the browser, display the inspection image, set the image inspection apparatus, and change parameters regarding image inspection.

The wireless LAN router 33 functions as an access point of a wireless LAN and can be connected to various terminals such as a PC and a tablet terminal through a wireless network. The wireless LAN router 33 performs data transmission related to displaying the inspection image acquired by the image inspection apparatus 10, changing parameters of the image inspection apparatus 10, and the like.

The PLC 40 has a function of performing PLC communication through the networks 21 and 22 and performing sequence control on each device of the image inspection system. The image inspection apparatus 10 is operable according to predetermined sequence control such as starting image inspection by a control signal (trigger signal) of an inspection start instruction received from the PLC 40.

### Configuration Example of Image Inspection Apparatus

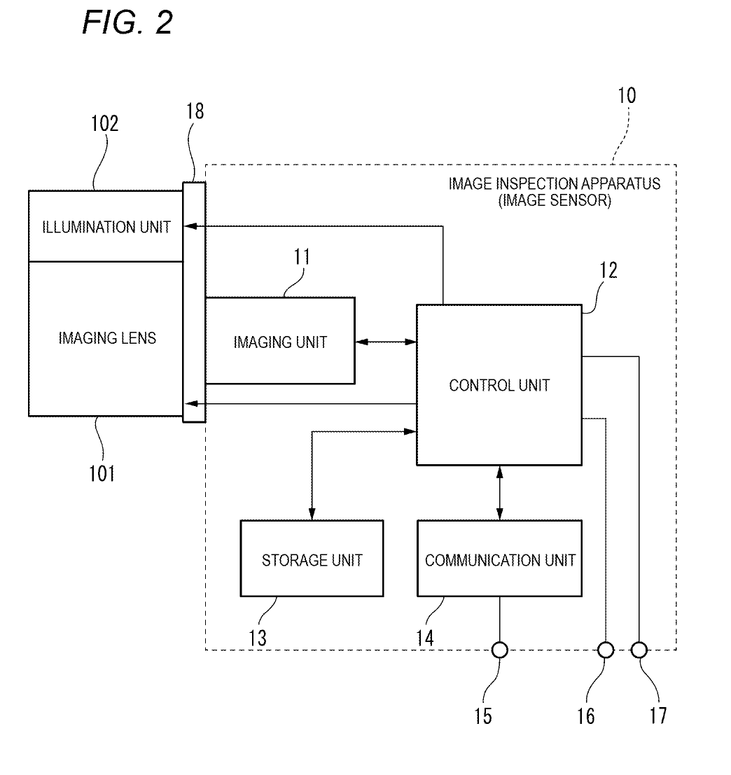

FIG. 2 is a block diagram illustrating a configuration example of the image inspection apparatus according to the present embodiment. The image inspection apparatus 10 includes an imaging unit 11, a control unit 12, a storage unit 13, and a communication unit 14. The image inspection apparatus 10 is configured to mount an imaging lens 101 and an illumination unit 102 on a lens mounting portion 18. The image inspection apparatus 10 is used for image inspection by mounting the imaging lens 101 having appropriate optical characteristics according to an installation location or an inspection target and also mounting the illumination unit 102 having appropriate lighting characteristics when necessary.

The imaging unit 11 includes a solid-state imaging element constituted by a charge coupled device (CCD) type image sensor, a complementary metal oxide semiconductor (CMOS) type image sensor, or the like. The imaging unit 11 captures an image of an inspection target which is a subject of which the image is formed by the imaging lens 101 under the control of the control unit 12 and outputs an imaging signal.

The control unit 12 includes a processor such as a CPU, and performs control process for controlling the overall operations of units of the image inspection apparatus 10, data input and output process between the image inspection apparatus 10 and an external terminal or device, data arithmetic operation (calculation) process, and data storage process. The storage unit 13 includes a memory such as a RAM or a ROM, and stores various information such as a firmware program for controlling the operation of the image inspection apparatus 10, a predetermined image inspection program for executing image inspection, setting data including various setting items and parameters regarding image inspection, image data of the captured image captured by the imaging unit 11, and inspection result data acquired through image inspection.

The control unit 12 processes an imaging signal of an inspection target of which the image is captured by the imaging unit 11 and outputs the processed imaging signal as the captured image that is a moving image or a still image. The control unit 12 processes the captured image and inspects an inspection item according to a predetermined image inspection program, and generates the inspection image including image information and inspection result information of the captured image. Meanwhile, a configuration may also be adopted in which a plurality of imaging units 11 are provided to be connected to the control unit 12 and are controlled by the control unit 12.

The control unit 12 has a function of a web server, and generates and outputs web contents for performing screen display of inspection image information including the inspection image for displaying the captured image, inspection results, and the like, image inspection-related information regarding image inspection, and the like, based on an access request using a general-purpose protocol such as HTTP from the PC 31 or the monitor terminal 32. The image inspection-related information includes inspection setting information including various setting items and parameters regarding image inspection and system setting information including various setting information of the image inspection system.

The control unit 12 executes processing based on predetermined authentication information regarding access from an external terminal or device such as the PC 31 or the monitor terminal 32. As the authentication information, character input information such as a password may be used. As the authentication information, identification information usable for various authentications through a network such as a bar code, a two-dimensional code, authentication key information using an encryption key, or an electronic certificate may be used. As the authentication information, device ID information for identifying a specific terminal or device such as a MAC address of the device, an IP address uniquely allocated to the device, a serial number of the device, or a terminal identification number may be used. As the authentication information, user ID information for identifying a specific user such as ID information like the user's ID card, face authentication information of the user, or biological authentication information such as a fingerprint, a vein pattern, and an iris pattern may be used.

The communication unit 14 including a network interface for connection to a network such as Ethernet (registered trademark) communicates with an external terminal or device connected thereto through the network and transmits authentication information, image information, setting information, inspection result information, and the like. The communication unit 14 communicates with the PC 31, the monitor terminal 32, and the like using a general-purpose protocol such as HTTP.

The communication unit 14 may include a wireless communication interface for connection to a wireless network such as a wireless LAN or a mobile communication network. The communication unit 14 may include a wireless communication interface for connection to an external terminal or device through near field communication such as Bluetooth (registered trademark).

The image inspection apparatus 10 includes a communication terminal 15, a power source and signal input terminal 16, and an illumination power source input terminal 17 as terminals for connection to the outside. The communication terminal 15, which is an input and output terminal for external communication, is connected to the communication unit 14 and is configured to include a connector for connecting to a network cable. The communication unit 14 is connected to the network 21 through the communication terminal 15. The power source and signal input terminal 16, which is an input terminal for inputting a power source and an external signal of the image inspection apparatus 10, is connected to the control unit 12 and is configured to include a connector for connecting to a signal cable. The power source of the image inspection apparatus 10 is supplied through the power source and signal input terminal 16. A control signal from the external PLC 40 or the like is input through the power source and signal input terminal 16. The illumination power source input terminal 17, which is an input terminal for inputting an illumination power source, is connected to the illumination unit 102 mounted outside through the control unit 12 and the lens mounting portion 18, and is configured to include a connector for connecting to a power source cable. The power source of the illumination unit 102 is supplied through the illumination power source input terminal 17.

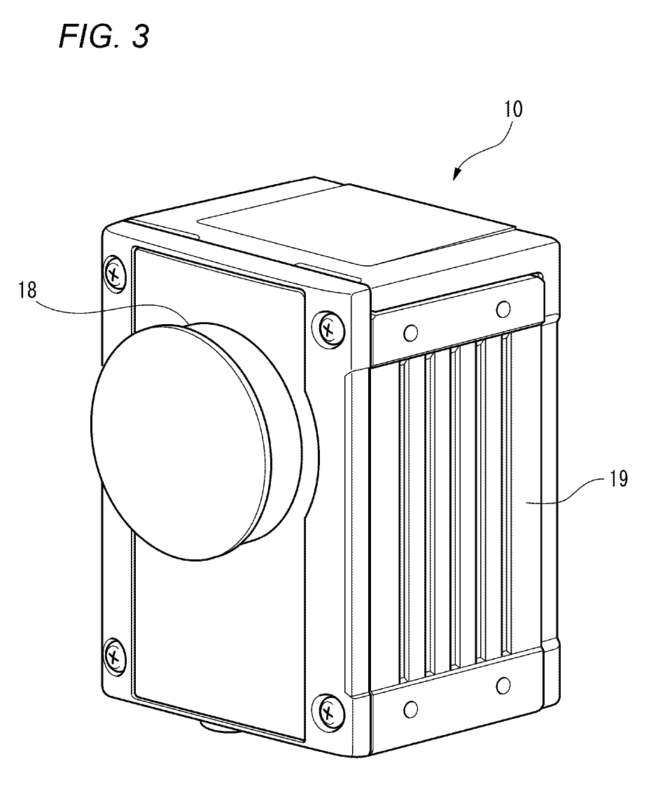

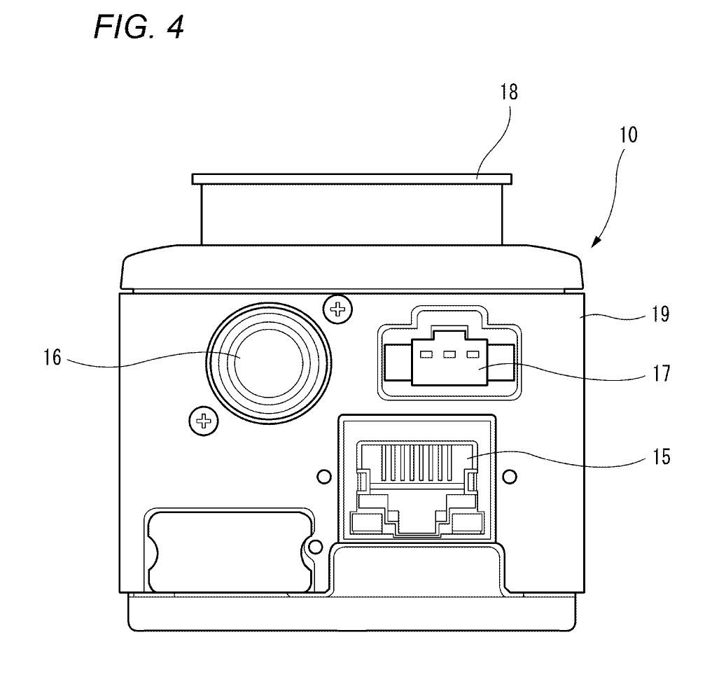

FIG. 3 is a perspective view illustrating an example of an exterior configuration of the image inspection apparatus according to the present embodiment, and FIG. 4 is a bottom view illustrating an example of an exterior configuration of the image inspection apparatus according to the present embodiment.

The image inspection apparatus 10 is configured to include a housing 19 having a substantially rectangular parallelepiped shape (box shape), and inside the housing 19, there is accommodated a substrate on which the control unit 12, the storage unit 13, and the communication unit 14 are mounted thereon. The lens mounting portion 18 is provided on one side surface of the housing 19, and the imaging unit 11 is disposed inside the lens mounting portion 18. The communication terminal 15, the power source and signal input terminal 16, and the illumination power source input terminal 17 are disposed on the bottom surface of the housing 19.

### Configuration Example of Program Creating Apparatus

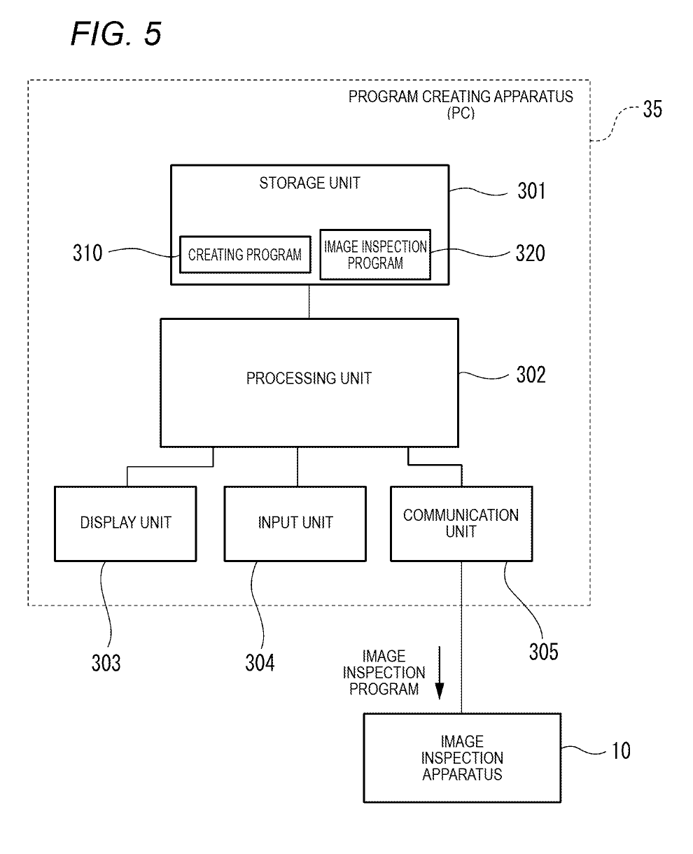

FIG. 5 is a block diagram illustrating a configuration example of a program creating apparatus according to the present embodiment. A program creating apparatus 35 is constituted by an information processing apparatus such as a PC or a tablet terminal. The program creating apparatus 35 includes a storage unit 301, a processing unit 302, a display unit 303, an input unit 304, and a communication unit 305.

The processing unit 302 includes a processor such as a CPU, and performs creating processing of the image inspection program, operation confirmation (simulation) processing of the image inspection program, data input and output processing between the program creating apparatus 35 and the image inspection apparatus 10, data arithmetic operation (calculation) processing, and data storage processing. The storage unit 301 includes a memory such as a RAM or a ROM, and stores a creating program 310 for executing the creating processing of the image inspection program and the operation confirmation processing of the image inspection program and a created image inspection program 320. The storage unit 301 stores various pieces of information such as various material data and various setting data of an image inspection program. A storage device such as a hard disk drive (HDD) or a solid state drive (SSD) may be provided as the storage unit 301.

The processing unit 302 creates an image inspection program based on a user's operation in accordance with the creating program 310, executes a simulation of the image inspection program to confirm operation, and stores the created image inspection program 320 in the storage unit 301. The processing unit 302 transmits the created image inspection program 320 to the image inspection apparatus 10 by the communication unit 305 and transports the image inspection program to the image inspection apparatus 10 to install the image inspection program.

The display unit 303 includes a display device such as a liquid crystal display or an organic electro-luminescence (EL) display and displays an application execution screen of a creating program by the processing unit 302, and the like. The input unit 304 includes an input device such as a keyboard, a mouse, a touchpad, or a touch panel, and inputs a user's operation for creating an image inspection program to the processing unit 302. The communication unit 305 includes a network interface for connecting to a network such as Ethernet (registered trademark), communicates with the image inspection apparatus 10 connected thereto through a network and transmits program information, setting information, and the like regarding the created image inspection program.

The program creating apparatus 35 may be connected to the image inspection apparatus 10 through a single network, or can also be directly connected to the image inspection apparatus 10.

The program creating apparatus 35 according to the present embodiment arbitrarily allocates and connects items related to image inspection according to a user's operation in the creating program 310 and describes a flowchart to create an image inspection program including inspection items according to the flowchart. In this manner, the image inspection program is created according to the flowchart, and thus it is possible to easily and flexibly create a desired image inspection program.

### First Embodiment

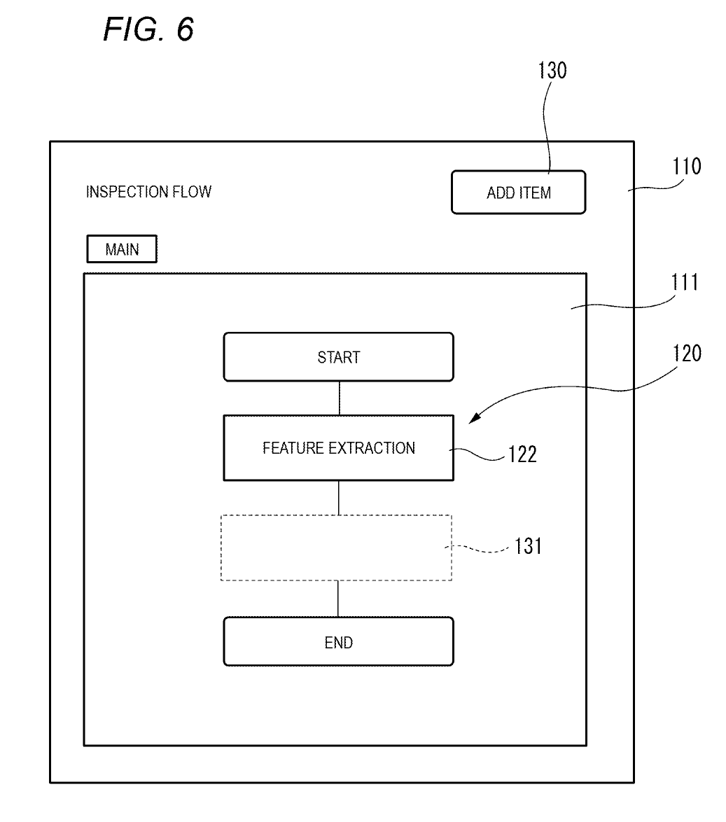

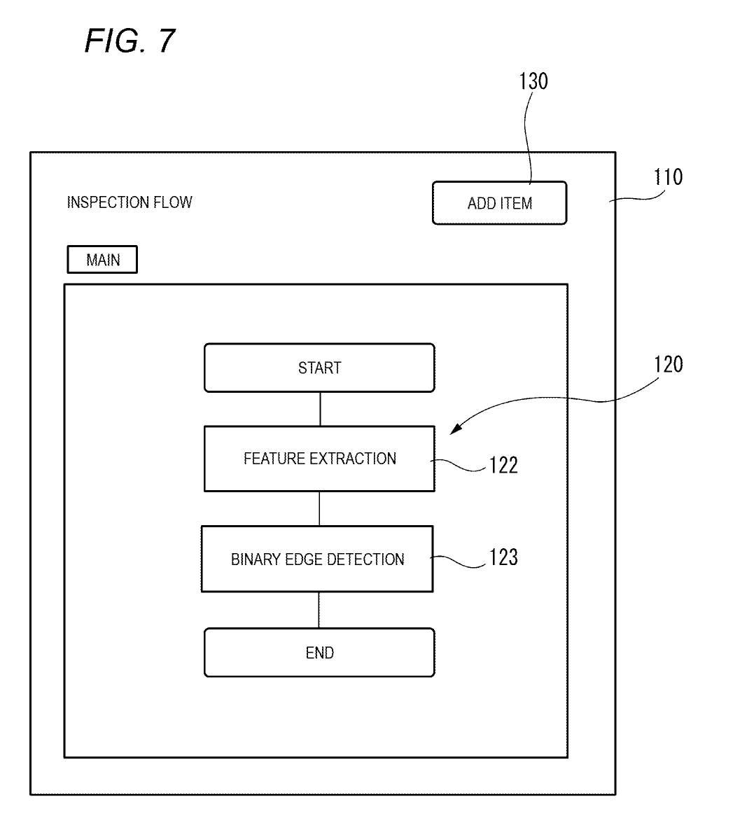

FIGS. 6 and 7 are diagrams illustrating an example of a program creating screen according to a first embodiment. The first embodiment illustrates, as an example of a program creating method, an example in which processing items of respective items and processing information such as processing results corresponding to the processing items are displayed when an image inspection program is created according to a flowchart.

The program creating apparatus 35 operates the creating program 310 to display a program creating screen 110 as illustrated in FIG. 6 and to create an image inspection program. The program creating screen 110 includes a flowchart display region 111 and an add item button 130, and a flowchart 120 of an image inspection program which is a creating target is displayed in the flowchart display region 111. In the example illustrated in the drawing, the flowchart 120 corresponding to main processing is illustrated as an inspection flow of the image inspection program.

A user operates the add item button 130 to select a desired item from various elements related to image inspection and disposes the selected item between Start and End, thereby describing and configuring the flowchart 120 of the image inspection program having a desired processing procedure. In the example illustrated in the drawing, illustrated is a mode in which a selected processing item 131 is added to the flowchart 120, thereby adding the description of the flowchart 120. In FIG. 6, the selected processing item 131 is disposed after a processing item of feature extraction 122. Therefore, as illustrated in FIG. 7, the flowchart 120 including a processing item of the feature extraction 122 and a processing item of a binary edge detection 123 is created. In the program creating apparatus 35 according to the present embodiment, it is possible to simultaneously display processing items of respective items as described below and processing information such as processing results corresponding to the processing items.

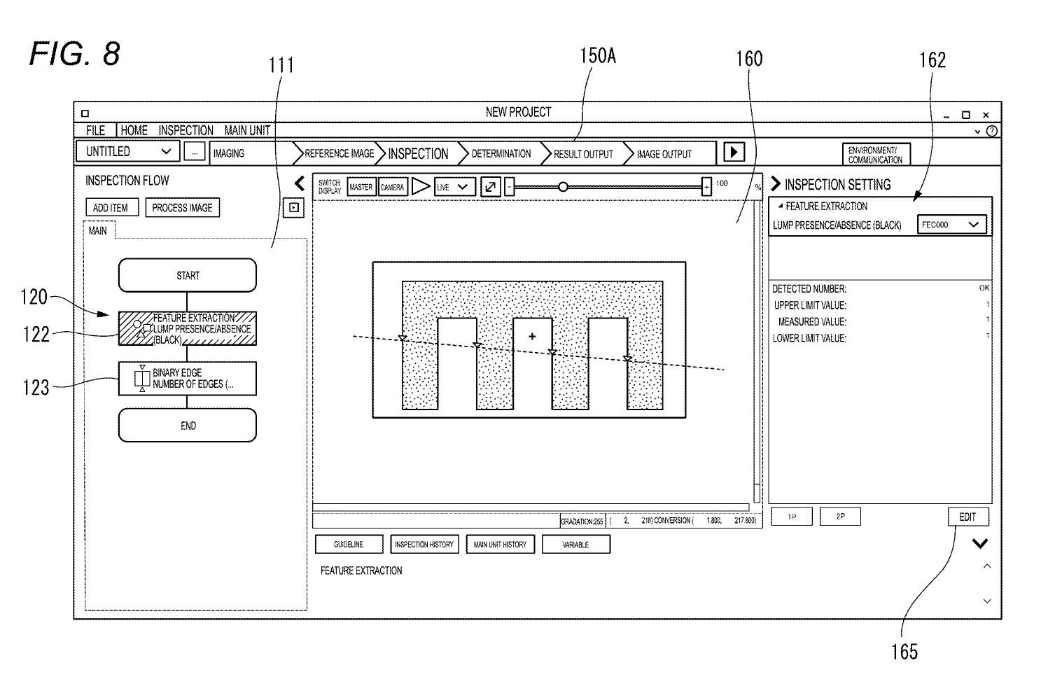

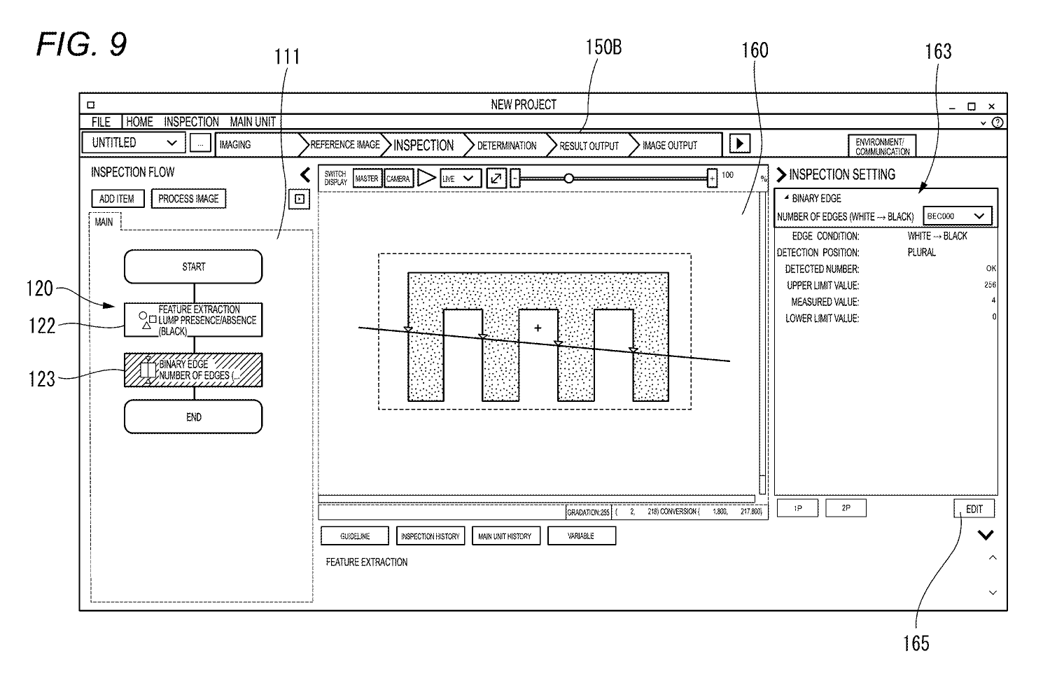

FIGS. 8 and 9 are diagrams illustrating an example of a program confirmation screen according to the first embodiment. On a program creating screen 150A illustrated in FIG. 8, an inspection image 160 is displayed beside the flowchart display region 111, and a processing information display 162 is displayed next thereto. As the inspection image 160, a sample image which is an object of a processing item of image inspection, such as a captured image of an inspection target captured in the past, a processed image obtained by performing image processing on a captured image, or a model image of an inspection target, is used. The processing information display 162 displays processing information indicating various conditions or results in the respective processing items of an inspection flow, such as an inspection region, an inspection condition, a processing condition, a determination condition, a measured value, a processing result and a determination result as inspection setting information or inspection result information corresponding to the processing items.

In the present embodiment, when a user selects any processing item of the flowchart 120 of the program creating screen, processing information corresponding to the selected processing item is displayed in the processing information display 162. When a user selects the processing item of the feature extraction 122 in the flowchart 120, a processing information display 162 of feature extraction corresponding to the selected processing item of the feature extraction 122 is displayed on the program creating screen 150A of FIG. 8. As the processing information display 162 of the feature extraction, for example, an upper limit value (1), a lower limit value (1), a measured value (1), and a determination result (OK) of a detected number are displayed. In this case, in the feature extraction processing, the number of black lumps (presence or absence) is detected as feature extraction in the inspection image 160, it is determined whether or not the detected number (measured value) is between the upper limit value and the lower limit value, and processing results indicating the measured value of 1 and the determination result of OK are obtained.

When a user selects the processing item of the binary edge detection 123 in the flowchart 120, a processing information display 163 of a binary edge corresponding to the selected processing item of the binary edge detection 123 is displayed on a program creating screen 150B of FIG. 9 As the processing information display 163 of the binary edge, for example, an edge condition (white→black), a detection position (plural), and an upper limit value (256), a lower limit value (0), a measured value (4), and a determination result (OK) of a detected number are displayed. In this case, in the binary edge processing, the number of edges changing from white to black is detected as the detection of the binary edge in the inspection image 160, it is determined whether or not the detected number (measured value) is between the upper limit value and the lower limit value, and processing results indicating the measured value of 4 and the determination result of OK are obtained.

The program creating apparatus 35 may display processing information corresponding to each processing item on the program creating screen. For example, processing information such as OK or NG of a processing result is displayed for each of the feature extraction 122 and the binary edge detection 123 as a plurality of processing items. In this case, results for each processing item on the flowchart 120 are drawn, and a user can confirm whether or not the assumed result of each processing item is obtained in the set flowchart. When the user selects any processing item, processing information corresponding to the selected processing item is displayed as in the example illustrated in the drawing. In this manner, it is also possible to adopt a display mode for performing a two-stage display including a simple display and a detailed display with respect to processing information. For example, when there is a problem in any one of the processing items, the user can determine which processing item is NG at a glance based on processing information indicating results. Further, when the user selects a processing item, the user can grasp detailed information indicating conditions and results of the processing item at a glance, and thus it is possible to simply confirm the cause of the problem.

The program creating apparatus 35 may simultaneously display processing information regarding conditions such as an inspection region, an inspection condition, a processing condition and a determination condition, and processing information regarding results such as a measured value, a processing result, and a determination result on the program creating screen. In this case, a user can visually recognize conditions and results with respect to processing items on the same screen at a glance. For example, when there is a problem in any one of the processing items, it is possible to simply confirm the cause of the problem with reference to conditions and results.

In FIGS. 8 and 9, when processing information such as setting values of the upper limit value and the lower limit value is changed, a user operates an edit button 165 and inputs an adjusted value to enable a change in setting.

As described above, pieces of processing information corresponding to respective processing items are individually displayed, and thus the user can grasp detailed processing information such as processing information indicating whether or not setting of conditions such as the upper limit value and the lower limit value in each processing item is appropriate and processing information indicating the degree of a problem when there is a problem in the setting. Therefore, the user can recognize the state and results in each of the processing items and can accurately obtain information for confirming the operation of an image inspection program, such as specification of a processing item having a problem and an indication of adjustment of a setting value.

According to the present embodiment, a flowchart is described by allocating items including processing items related to image inspection on the program creating screen when an image inspection program to be operated in the image inspection apparatus 10 is created, and thus it is possible to easily create the image inspection program including desired image inspection items and procedures. Processing information indicating conditions or results corresponding to each processing item is displayed on the program creating screen, and thus it is possible to simply confirm detailed information regarding each of the processing items. A processing item selected by a user and processing information indicating various conditions or results corresponding to the processing item are simultaneously displayed on the program creating screen, and thus it is possible to easily confirm and grasp detailed information such as inspection conditions and processing results related to each of the processing items. Therefore, it is possible to improve operability and visibility such as operation confirmation and condition confirmation for each processing item when an image inspection program is created. It is possible to perform detailed operation confirmation for each processing item in the image inspection program.

As described above, the program creating apparatus 35 for an image inspection program according to the present embodiment is the program creating apparatus 35 that creates the image inspection program 320 used in the image inspection apparatus 10 that captures an image of an inspection target and executes image inspection of the inspection target, and includes the processing unit 302 that executes processing including the creating processing of the image inspection program and the operation confirmation processing of the image inspection program. The processing unit 302 displays the program creating screen related to the creating of the image inspection program on the display device and describes a flowchart by allocating items including processing items related to image inspection in accordance with a user's operation on the program creating screen, thereby creating an image inspection program including image inspection items according to the flowchart. The processing unit 302 displays processing information corresponding to each processing item of the flowchart on the program creating screen. Therefore, it is possible to easily confirm and grasp information such as inspection conditions and processing results related to each of the processing items on the program creating screen.

In the program creating apparatus 35, the processing unit 302 displays processing information corresponding to a processing item selected by a user's operation from the processing items of the flowchart on the program creating screen together with the selected processing item. Therefore, it is possible to easily confirm and grasp information such as inspection conditions and processing results related to each of the processing items on the program creating screen. As a result, it is possible to improve operability and visibility such as operation confirmation and condition confirmation for each processing item when an image inspection program is created. In addition, it is possible to perform detailed operation confirmation for each processing item in the image inspection program.

In the program creating apparatus 35, processing information corresponding to a processing item to be displayed on the program creating screen is set to be information indicating conditions or results including at least one of the inspection region, the inspection condition, the processing condition, the determination condition, the measured value, the processing result and the determination result in the processing item. Therefore, it is possible to confirm and grasp various conditions or processing results in detail with respect to the inspection region, the inspection condition, the processing condition, the determination condition, the measured value, the processing result and the determination result related to the processing item.

In the program creating apparatus 35, processing information corresponding to a processing item to be displayed on the program creating screen is set to be information including at least one of the inspection region, the inspection condition, the processing condition and the determination condition, and at least one of the measured value, the processing result and the determination result in the processing item. Therefore, conditions and results corresponding to the processing item are simultaneously displayed so that a user can simply confirm the conditions and the results.

In the program creating apparatus 35, the processing unit 302 makes it possible to input a change in processing information on the program creating screen. Therefore, it is possible to appropriately change inspection conditions and the like after confirming detailed information such as inspection conditions and processing results regarding a processing item.

An image inspection program creating method according to the present embodiment is a program creating method used in the program creating apparatus 35 that creates an image inspection program used in the image inspection apparatus 10 that captures an image of an inspection target and executes image inspection of the inspection target. The processing unit 302 of the program creating apparatus 35 executes processing including the creating processing of the image inspection program and the operation confirmation processing of the image inspection program, displays a program creating screen related to the creating of the image inspection program on a display device, and describes a flowchart by allocating items including processing items related to image inspection in accordance with a user's operation on the program creating screen, thereby creating an image inspection program including image inspection items according to the flowchart. Processing information corresponding to each processing item of the flowchart is displayed on the program creating screen.

A creating program for an image inspection program according to the present embodiment is a creating program causing a computer to execute each processing of the program creating method in the program creating apparatus 35 that creates the image inspection program used in the image inspection apparatus 10 that captures an image of an inspection target and executes image inspection of the inspection target. In the program, processing including the creating processing of the image inspection program and the operation confirmation processing of the image inspection program is executed, a program creating screen related to the creating of an image inspection program is displayed on a display device, and a flowchart is described by allocating items including processing items related to image inspection in accordance with a user's operation on the program creating screen, thereby creating an image inspection program including image inspection items according to the flowchart. Processing information corresponding to each processing item of the flowchart is displayed on the program creating screen.

### Second Embodiment

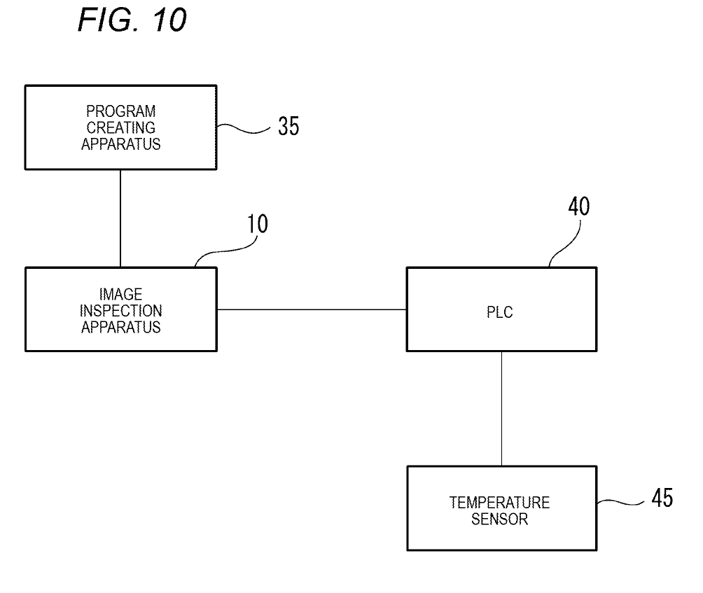

FIG. 10 is a block diagram illustrating an example of a connection configuration of a program creating apparatus according to a second embodiment. The second embodiment illustrates, as an example of a program creating method, an example in which an input signal and an output signal of the image inspection apparatus are allocated to any locations when an image inspection program is created according to a flowchart.

Here, as illustrated in FIG. 10, in an image inspection system, a case where the image inspection apparatus 10 and a PLC 40 are connected to each other and an instruction is transmitted from the PLC 40 to the image inspection apparatus 10 to execute image inspection is assumed. The PLC 40 inputs an instruction to the image inspection apparatus 10 using measurement results of a temperature sensor 45, and the image inspection apparatus 10 performs image inspection based on the input of the instruction from the PLC 40. A program creating apparatus 35 creates an image inspection program to be executed in the image inspection apparatus 10 and transports and inputs the created image inspection program to the image inspection apparatus 10.

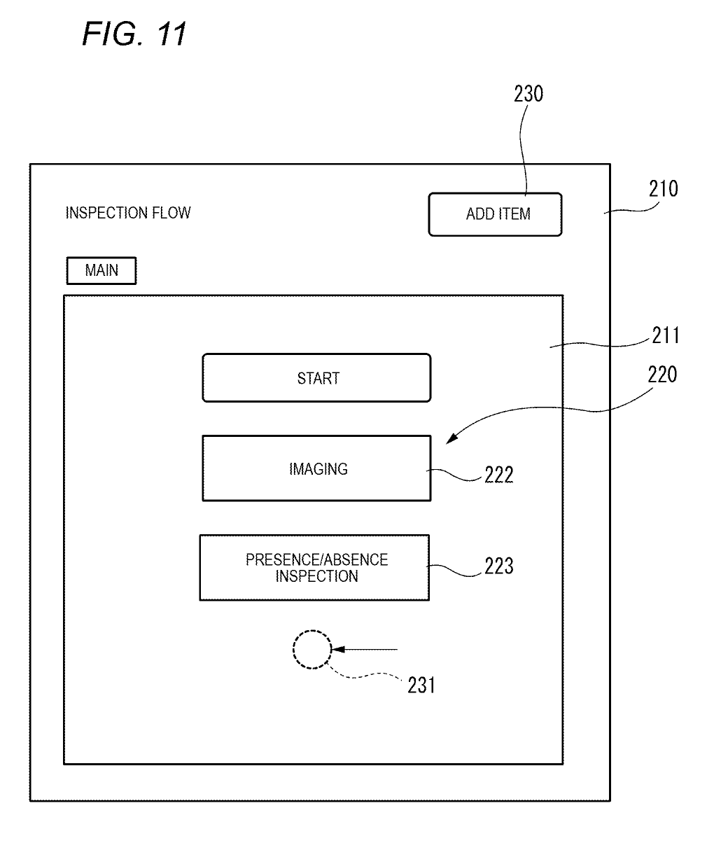

FIG. 11 is a diagram illustrating an example of a program creating screen according to the second embodiment. A program creating screen 210 includes a flowchart display region 211 and an add item button 230, and a flowchart 220 of an image inspection program which is a creating target is displayed in the flowchart display region 211. In the example illustrated in the drawing, the flowchart 220 corresponding to main processing is illustrated as an inspection flow of the image inspection program.

A user operates the add item button 230 to select a desired item from various elements related to image inspection and disposes the selected item between Start and End, thereby describing and configuring the flowchart 220 of the image inspection program having a desired processing procedure. In the example illustrated in the drawing, illustrated is a mode in which a selected signal input item 231 is added to the flowchart 220, thereby adding the description of the flowchart 220. In FIG. 11, a processing item of imaging 222 and a processing item of presence or absence inspection 223 are disposed, and the signal input item 231 is disposed after the processing item of the presence and absence inspection 223 to allocate an input signal of I/O of the image inspection apparatus 10. Meanwhile, similarly to the input signal, a signal output item can also be disposed to allocate an output signal of I/O of the image inspection apparatus 10.

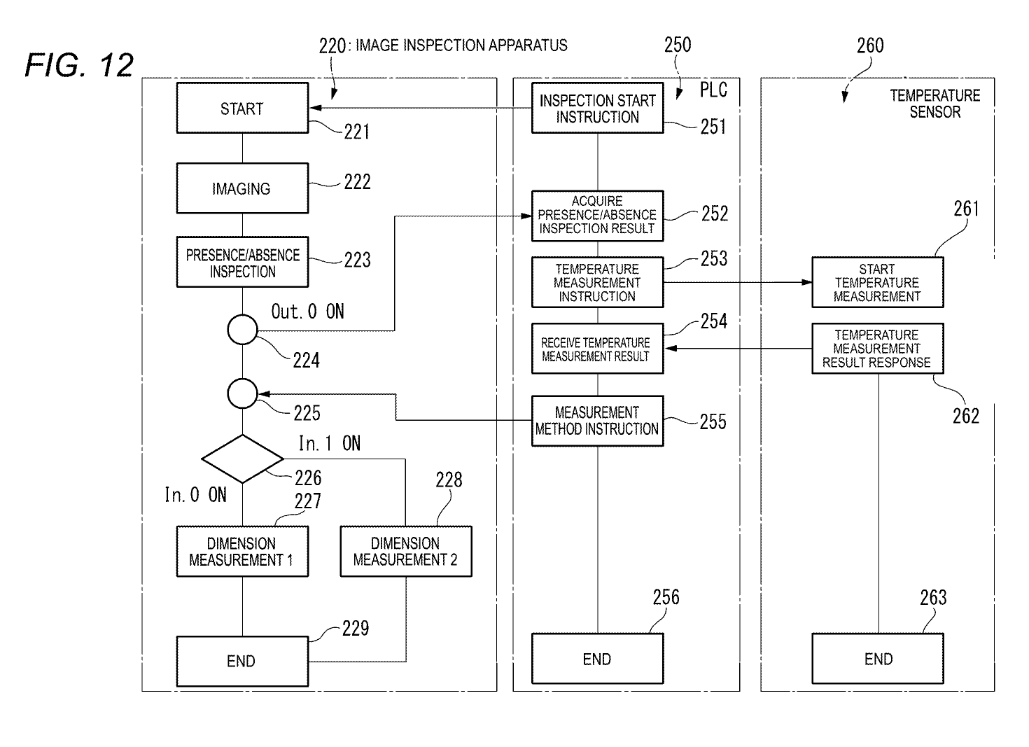

FIG. 12 is a diagram illustrating an example of an image inspection program according to the second embodiment. In FIG. 12, the flowchart 220 of an operation procedure of the image inspection apparatus 10, a flowchart 250 of an operation procedure of the PLC 40, and a flowchart 260 of an operation procedure of the temperature sensor 45 are illustrated as flowcharts of the image inspection program.

In the present embodiment, an output signal (Out. 0 ON) 224 and an input signal (In. 0 ON or In. 1 ON) 225 are allocated after the presence or absence inspection 223 in the flowchart 220 of the operation procedure of the image inspection apparatus 10. A determination element 226 for determining the type of input signal (In. 0 ON or In. 1 ON) 225 is added, and processing is divided according to a determination result. First dimension measurement (dimension measurement 1) 227 is executed in a case of the input signal (In. 0 ON), and second dimension measurement (dimension measurement 2) 228 is executed in a case of the input signal (In. 1 ON).

In the image inspection program in the example illustrated in the drawing, the PLC 40 transmits an inspection start instruction 251 to the image inspection apparatus 10, and the image inspection apparatus 10 receives the inspection start instruction from the PLC 40 to start image inspection (221). The image inspection apparatus 10 performs the imaging 222 of an inspection target and performs the presence or absence inspection 223 of the inspection target on a captured image. The image inspection apparatus 10 transmits the output signal (Out. 0 ON) 224 to the PLC 40 as a result of the presence or absence inspection.

The PLC 40 acquires the result of the presence or absence inspection (252) and transmits a temperature measurement instruction 253 to the temperature sensor 45 when Out. 0 of I/O of the image inspection apparatus 10 is turned on, thereby giving an instruction to measure the temperature of the inspection target. The temperature sensor 45 receives the temperature measurement instruction from the PLC 40 to start to measure the temperature of the inspection target (261). The temperature sensor 45 transmits a temperature measurement result response 262 indicating a temperature measurement result to the PLC 40. The PLC 40 receives the temperature measurement result from the temperature sensor 45 (254) and transmits a measurement method instruction 255 based on the temperature of the inspection target to the image inspection apparatus 10. The PLC 40 instructs either the dimension measurement 1 or the dimension measurement 2 depending on which of In. 0 and In. 1 of I/O of the image inspection device 10 is turned on in accordance with the temperature measurement result.

The image inspection apparatus 10 receives the input signal (In. 0 ON or In. 1 ON) 225 as the measurement method instruction received from the PLC 40. The image inspection apparatus 10 determines whether the input signal of I/O is In. 0 ON or In. 1 ON (226). When In. 0 of I/O is turned on, the image inspection apparatus 10 performs the first dimension measurement (dimension measurement 1) 227. On the other hand, when In. 1 of I/O is turned on, the image inspection apparatus 10 performs the second dimension measurement (dimension measurement 2) 228. As described above, the image inspection processes of the image inspection apparatus 10, the PLC 40 and the temperature sensor 45 are terminated (229, 256 and 263).

As described above, it is possible to execute processing based on an input signal by allocating the input signal to any locations in the image inspection program. For example, it is possible to execute processing by changing conditions of a desired inspection item in accordance with contents of an input signal such as the presence or absence of an input signal and the type of the input signal. It is also possible to execute different processing depending on contents of an input signal. Therefore, it is possible to create an image inspection program capable of setting image inspection based on the input signal. It is possible to execute flexible image inspection based on various conditions, such as the preparation of another processing item or skipping of a specific processing item, in accordance with contents of the input signal. It is possible to freely create an image inspection program for executing an inspection item in association with an external device such as a PLC or a sensor as appropriate by allocating the output signal to any locations in the image inspection program.

According to the present embodiment, a flowchart is described by allocating items including processing items related to image inspection on the program creating screen when an image inspection program to be operated in the image inspection apparatus 10 is created, and thus it is possible to easily create the image inspection program including desired image inspection items and procedures. It is possible to realize a flexible configuration of the image inspection program by making it possible to allocate an input signal and/or an output signal to any locations of the flowchart on the program creating screen. In this case, it is possible to create an image inspection program capable of executing a more appropriate image inspection item by allocating an input signal or an output signal to a desired location in the processing procedure without being limited to the time when the program is started or the time immediately before the program is terminated.

As described above, the program creating apparatus 35 for an image inspection program according to the present embodiment is the program creating apparatus 35 that creates the image inspection program 320 used in the image inspection apparatus 10 that captures an image of an inspection target and executes image inspection of the inspection target, and includes the processing unit 302 that executes processing including the creating processing of the image inspection program and the operation confirmation processing of the image inspection program. The processing unit 302 displays a program creating screen related to the creating of the image inspection program on a display device and describes a flowchart by allocating items including processing items related to image inspection in accordance with a user's operation on the program creating screen, thereby creating an image inspection program including image inspection items according to the flowchart. The processing unit 302 includes a signal input item as an item in the program creating screen and can allocate an input signal of the image inspection apparatus 10 to any locations in the flowchart.

Therefore, it is possible to create an image inspection program capable of executing a more appropriate image inspection item by allocating an input signal to a desired location in the processing procedure without being limited to the time when the program is started. As a result, it is possible to realize a flexible configuration of the image inspection program and to accurately operate a desired image inspection in the image inspection apparatus 10. Therefore, it is possible to execute image inspection in which an input is allocated to any locations in the image inspection program.

In the program creating apparatus 35, the processing unit 302 includes a signal output item as an item in the program creating screen and can allocate an output signal of the image inspection apparatus 10 to any locations in the flowchart. Therefore, it is possible to create an image inspection program capable of executing a more appropriate image inspection item by allocating an output signal to a desired location in the processing procedure without being limited to the time immediately before the program is terminated. It is possible to flexibly create an image inspection program appropriately associated with an external device which is an output destination of an output signal. As a result, it is possible to realize a flexible configuration of the image inspection program and to execute image inspection in which an output is allocated to any locations in the image inspection program.

In the program creating apparatus 35, an input signal or an output signal of the image inspection apparatus 10 which is allocated in the flowchart is a signal which is input to or output from a programmable logic controller 40 controlling the image inspection apparatus 10. Therefore, an image inspection program for executing an inspection item in association with the programmable logic controller can be easily created with free condition setting.

An image inspection program creating method according to the present embodiment is a program creating method used in the program creating apparatus 35 that creates an image inspection program used in the image inspection apparatus 10 that captures an image of an inspection target and executes image inspection of the inspection target. The processing unit 302 of the program creating apparatus 35 executes processing including the creating processing of the image inspection program and the operation confirmation processing of the image inspection program, displays a program creating screen related to the creating of the image inspection program on a display device, and describes a flowchart by allocating items including processing items related to image inspection in accordance with a user's operation on the program creating screen, thereby creating an image inspection program including image inspection items according to the flowchart. A signal input item is provided as an item in the program creating screen, and it is possible to allocate an input signal of the image inspection apparatus 10 to any locations in the flowchart.

A creating program for an image inspection program according to the present embodiment is a creating program for causing a computer to execute each processing of the program creating method in the program creating apparatus 35 that creates the image inspection program used in the image inspection apparatus 10 that captures an image of an inspection target and executes image inspection of the inspection target. In the program, processing including the creating processing of the image inspection program and the operation confirmation processing of the image inspection program is executed, a program creating screen related to the creating of an image inspection program is displayed on a display device, and a flowchart is described by allocating items including processing items related to image inspection in accordance with a user's operation on the program creating screen, thereby creating an image inspection program including image inspection items according to the flowchart. A signal input item is provided as an item in the program creating screen, and it is possible to allocate an input signal of the image inspection apparatus 10 to any locations in the flowchart.

While various embodiments have been described with reference to the accompanying drawings, it is needless to say that the present invention is not limited to such examples. It is apparent for those skilled in the art to which the invention belongs that various modified examples or corrected examples are conceivable within the scope recited in the claims, and it is understood that the above falls within the technical scope of the invention. The components in the above-described embodiments may be arbitrarily combined with each other without departing from the scope of the invention.

One or more embodiments of the present invention are useful as a creating apparatus, a creating method, and a creating program for an image inspection program capable of simply performing detailed operation confirmation for each processing item in the image inspection program.

1. A program creating apparatus for an image inspection program, which creates the image inspection program used in an image inspection apparatus configured to capture an image of an inspection target and execute image inspection of the inspection target, the program creating apparatus comprising:
a processing unit configured to execute processing including creating processing of the image inspection program and operation confirmation processing of the image inspection program,
wherein the processing unit displays a program creating screen related to creating of the image inspection program on a display device, describes a flowchart by allocating items including processing items related to image inspection in accordance with a user's operation on the program creating screen, thereby creating an image inspection program including image inspection items according to the flowchart, and displays processing information corresponding to each of the processing items on the program creating screen.

2. The program creating apparatus for an image inspection program according to claim 1,
wherein the processing unit displays processing information corresponding to a processing item selected from the processing items by the user's operation on the program creating screen together with the selected processing items.

3. The program creating apparatus for an image inspection program according to claim 1,
wherein the processing information corresponding to the processing item is information indicating conditions or results including at least one of an inspection region, an inspection condition, a processing condition, a determination condition, a measured value, a processing result, and a determination result in the processing item.

4. The program creating apparatus for an image inspection program according to claim 3,
wherein the processing information corresponding to the processing item is information including: at least one of the inspection region, the inspection condition, the processing condition and the determination condition; and at least one of the measured value, the processing result and the determination result in the processing item.

5. The program creating apparatus for an image inspection program according to claim 1,
wherein the processing unit allows an input of a change in the processing information to be received on the program creating screen.

6. A program creating method for an image inspection program in a program creating apparatus configured to create the image inspection program used in an image inspection apparatus configured to capture an image of an inspection target and execute image inspection of the inspection target, the program creating method comprising:
executing, by a processing unit of the program creating apparatus, processing including creating processing of the image inspection program and operation confirmation processing of the image inspection program;
displaying, by the processing unit of the program creating apparatus, a program creating screen related to creating of the image inspection program on a display device, and describing a flowchart by allocating items including processing items related to image inspection in accordance with a user's operation on the program creating screen, thereby creating an image inspection program including image inspection items according to the flowchart; and
displaying, by the processing unit of the program creating apparatus, processing information corresponding to each of the processing items on the program creating screen.

7. A non-transitory computer readable medium storing a creating program for an image inspection program, which causes a computer to execute a program creating process in a program creating apparatus configured to create the image inspection program used in an image inspection apparatus configured to capture an image of an inspection target and execute image inspection of the inspection target, the program creating process comprising:
executing processing including creating processing of the image inspection program and operation confirmation processing of the image inspection program;
displaying a program creating screen related to creating of the image inspection program on a display device, and describing a flowchart by allocating items including processing items related to image inspection in accordance with a user's operation on the program creating screen, thereby creating an image inspection program including image inspection items according to the flowchart; and
displaying processing information corresponding to each of the processing items on the program creating screen.
